(19) United States
(12) Patent Application Publication
(10) Pub. No.: US 2014/0321043 A1
(43) Pub. Date: Oct. 30, 2014

(54) SUPPORTING STRUCTURE AND ELECTRONIC DEVICE USING THE SAME

(71) Applicant: Quanta Computer, Inc., Taoyuan Shien (TW)

(72) Inventors: Li-Chuan LIU, Taoyuan Shien (TW); Yin-Wei YEH, Xinzhuang City (TW); Kun-Ho LEE, Linkou Township (TW); Chih-Kai HSU, Taoyuan Shien (TW)

(73) Assignee: Quanta Computer, Inc., Taoyuan Shien (TW)

(21) Appl. No.: 14/027,096

(22) Filed: Sep. 13, 2013

(30) Foreign Application Priority Data
Apr. 24, 2013 (TW) 102207478

(51) Int. Cl. G06F 1/16

(52) U.S. Cl. CPC G06F 1/1654
USPC 361/679.29; 248/346.04

(57) ABSTRACT

A supporting structure includes a body, a first plate, a second plate, a first elastic assembly, and a second elastic assembly. The body has a groove used for accommodating a display panel. The first plate is disposed on a first side of the groove, and the second plate is disposed on a second side of the groove opposite to the first side. The first elastic assembly is pivotally connecting the first plate and the body, and the second elastic assembly is pivotally connecting the second plate and the body. The first elastic assembly and the second elastic assembly clamp the display panel when the display panel is inserted into the groove of the body. The first elastic assembly and the second elastic assembly together cover the groove when the display panel is detached from the body. An electronic device using the supporting structure is also disclosed.

### CROSS-REFERENCE TO RELATED APPLICATIONS

This application claims priority to Taiwan Application Serial Number 102207478, filed Apr. 24, 2013, which is herein incorporated by reference.

### FIELD OF THE INVENTION

The present disclosure relates to a supporting structure of a display panel.

### BACKGROUND

Nowadays, a multifunctional tablet computer not only has a display with touch function, but also is capable of operating with a keyboard for inputting signals. However, mechanism assemblies of the tablet computer to equip the keyboard in the conventional market are complicated and thus hard to be assembled. As such, the complicated mechanism assemblies may raise the manufacturing cost and compromise the appearance of the tablet. Also, users may likely to break down the mechanism assemblies while assembling or disassembling.

### SUMMARY

An aspect of the present invention provides a supporting structure. The supporting structure includes a body, a first plate, a second plate, a first elastic assembly, and a second elastic assembly. The body has a groove used for accommodating a display panel. The first plate is disposed on a first side of the groove. The second plate is disposed on a second side of the groove opposite to the first side. The first elastic assembly is pivotally connecting the first plate and the body. The second elastic assembly is pivotally connecting the second plate and the body. The first elastic assembly and the second elastic assembly clamp the display panel when the display panel is inserted to the groove of the body. The first elastic assembly and the second elastic assembly together cover the groove when the display panel is detached from the body.

Another aspect of the present invention provides an electronic device. The electronic device includes a display panel and a supporting structure. The supporting structure includes a body, a first plate, a second plate, a first elastic assembly, and a second elastic assembly. The body has a keyboard and a groove used for accommodating a display panel. The first plate is disposed on a first side of the groove. The second plate is disposed on a second side of the groove opposite to the first side. The first elastic assembly is pivotally connecting the first plate and the body. The second elastic assembly is pivotally connecting the second plate and the body. The first elastic assembly and the second elastic assembly clamp the display panel when the display panel is inserted to the groove of the body. The first elastic assembly and the second elastic assembly together cover the groove when the display panel is detached from the body.

### BRIEF DESCRIPTION OF THE DRAWINGS

FIG. 1 is a three-dimensional view of an electronic device according to an embodiment of the present invention;

FIG. 2 is a three-dimensional view of a display panel detached from a supporting structure both shown in FIG. 1;

FIG. 3 is an exploded view of the supporting structure of FIG. 1;

FIG. 4 is a cross-sectional view along line A-A of FIG. 2;

FIG. 5 and FIG. 6 are cross-sectional views of the display panel and the supporting structure along line A-A of FIG. 2 when the display panel is inserted to the supporting structure;

FIG. 7 and FIG. 8 are cross-sectional views of the display panel and the supporting structure when the display panel is detached from the supporting structure;

FIG. 9A is a three-dimensional view of a first elastic assembly according to another embodiment of the present invention;

FIG. 9B is a three-dimensional view of a second elastic assembly according to another embodiment of the present invention; and

FIG. 10 is a cross-sectional view of the electronic device according to another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

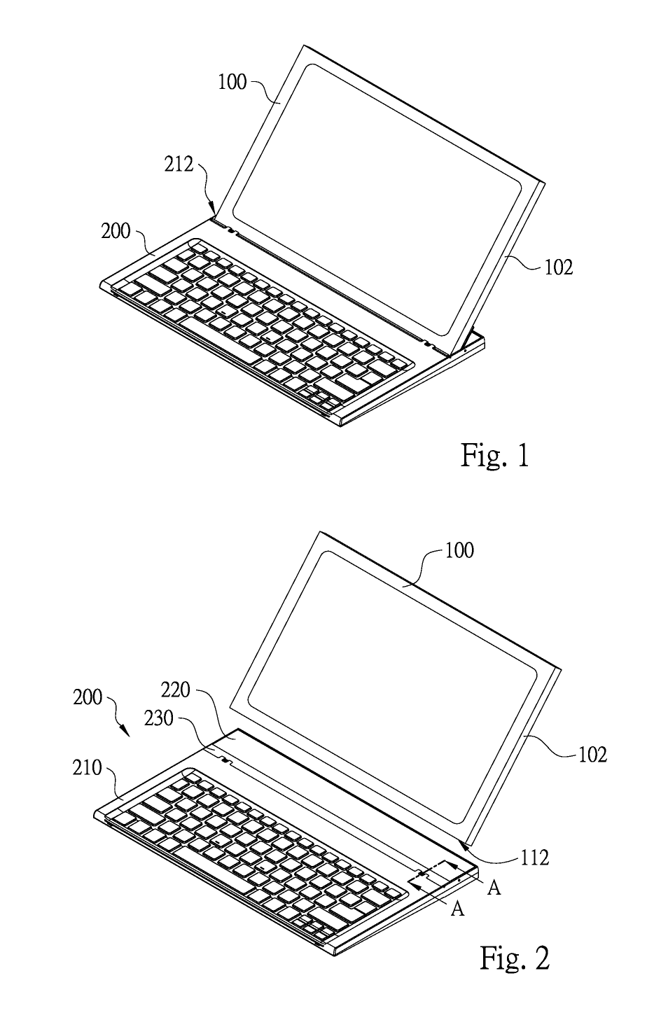

FIG. 1 is a three-dimensional view of an electronic device according to an embodiment of the present invention, and FIG. 2 is a three-dimensional view of a display panel 100 detached from a supporting structure 200 both shown in FIG. 1. The electronic device includes the display panel 100 and the supporting structure 200. The display panel 100 is detachable inserted to a groove 212 of the supporting structure 200 to form the conventional laptop type of electronic device. A side 112 of the display panel 100 can be accommodated in the groove 212 when the display panel 100 is inserted to the supporting structure 200, such that the display panel 100 stands on the supporting structure 200 as shown in FIG. 1. Moreover, the groove 212 of the supporting structure 200 is hidden by a first plate 220 and a second plate 230 together when the display panel 100 is detached from the supporting structure 200 as shown in FIG. 2 (details are in following). The electronic device of the present embodiment has advantages of easy assembling between the display panel 100 and the supporting structure 200, and good appearance aesthetic of the supporting structure 200.

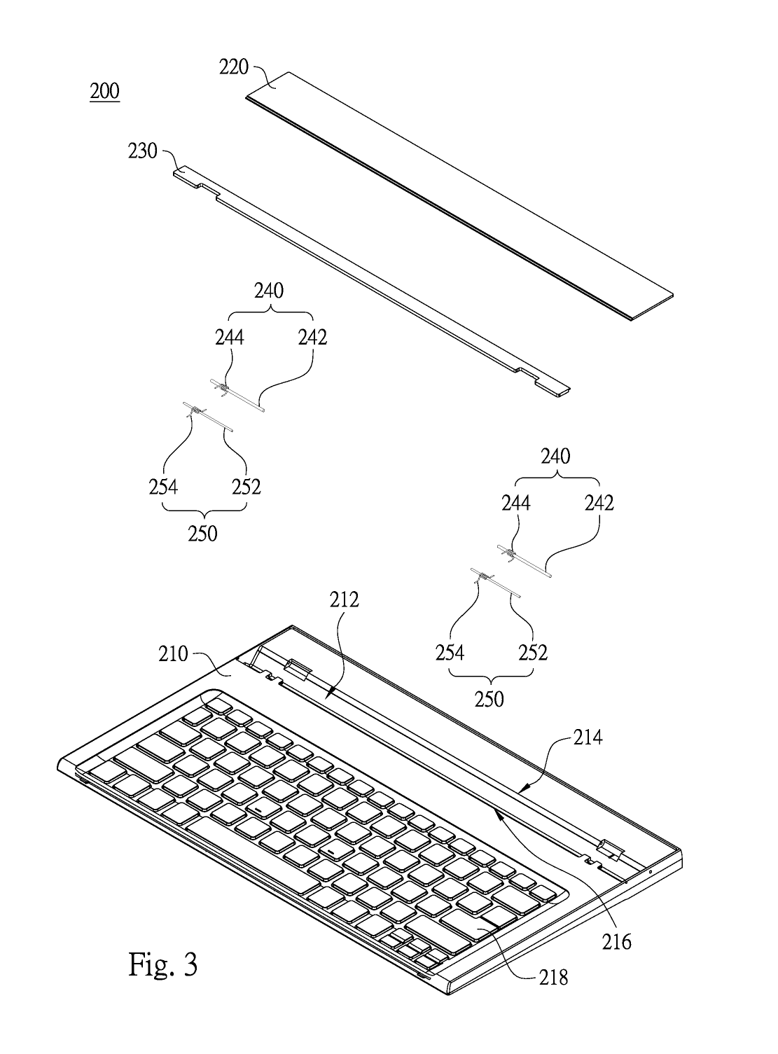

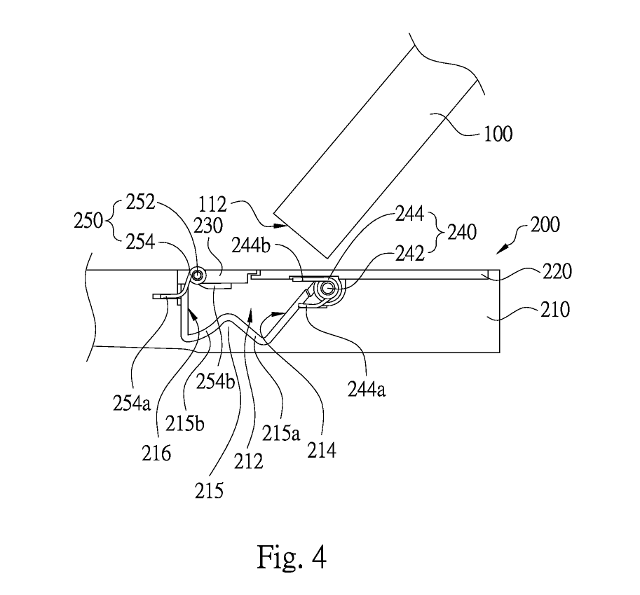

The details of the supporting structure 200 are described in following paragraphs. FIG. 3 is an exploded view of the supporting structure 200 of FIG. 1, and FIG. 4 is a cross-sectional view along line A-A of FIG. 2. The supporting structure 200 includes a body 210, a first plate 220, a second plate 230, a first elastic assembly 240, and a second elastic assembly 250. The body 210 has the groove 212 used for accommodating the side 112 of the display panel 100. The first plate 220 is rotatablely disposed on a first side 214 of the groove 212, and the second plate 230 is rotatablely disposed on a second side 216 of the groove 212 opposite to the first side 214. The groove 212 further includes a mountain-shaped structure 215 between the first side 214 and the second side 216. The mountain-shaped structure 215 has a first inclined plane 215a and a second inclined plane 215b respectively connecting the first side 214 and the second side 216. The first elastic assembly 240 is pivotally connecting the first plate 220 and the body 210. The second elastic assembly 250 is pivotally connecting the second plate 230 and the body 210.

In this embodiment, the first elastic assembly 240 includes a pivot 242 and a torque spring 244. The pivot 242, which threads the torque spring 244, is able to rotate relative to the body 210. A terminal 244a of the torque spring 244 is embedded into the body 210 fixedly, and the other terminal 244b of the torque spring 244 abuts against or is fixed on the first plate 220, such that the first plate 220 can rotate relative to the pivot 242.

Similarly, the second elastic assembly 250 includes a pivot 252 and a torque spring 254. The pivot 252, which threads the torque spring 254, is able to rotate relative to the body 210. A terminal 254a of the torque spring 254 is inserted into the body 210 fixedly from the second side 216, and the other terminal 254b of the torque spring 254 abuts against or is fixed on the second plate 230, such that the second plate 230 can rotate relative to the pivot 252. Consequently, the torque springs 244 and 254 respectively let the first plate 220 and the second plate 230 cover portions of the groove 230 when the display panel 100 and the supporting structure 200 are separated from each other.

It is noticed that although the numbers of the first elastic assembly 240 and the second elastic assembly 250 both are two in this embodiment, the scope of the claimed invention should not be limited in this respect. Other configurations fall within the scope of the claimed invention, such as the numbers of the first elastic assembly 240 and the second elastic assembly 250 both are one or above two.

Moreover, although in this embodiment, the terminal 244a of the torque spring 244 is embedded into the body 210, and the terminal 254a of the torque spring 254 is inserted into the body 210, the scope of the claimed invention should not be limited in this respect. Other configurations fall within the scope of the claimed invention, such as disposing the terminal 244a on the first side 214 of the groove 212, and/or disposing the terminal 254a on the second side 216 of the groove 212 as long as the terminals 244a and 254a are respectively fixed on the body 210. In addition, although in this embodiment, the terminal 244b of the torque spring 244 is disposed adjacent to the surface of the first plate 220, and the terminal 254b of the torque spring 254 is disposed adjacent to the surface of the second plate 230, the scope of the claimed invention should not be limited in this respect. Other configurations fall within the scope of the claimed invention, such as embedding the terminal 244b into the first plate 220, and/or embedding the terminal 254b into the second plate 230 as long as the terminals 244b and 254b are fixed on the first plate 220 and the second plate 230, respectively.

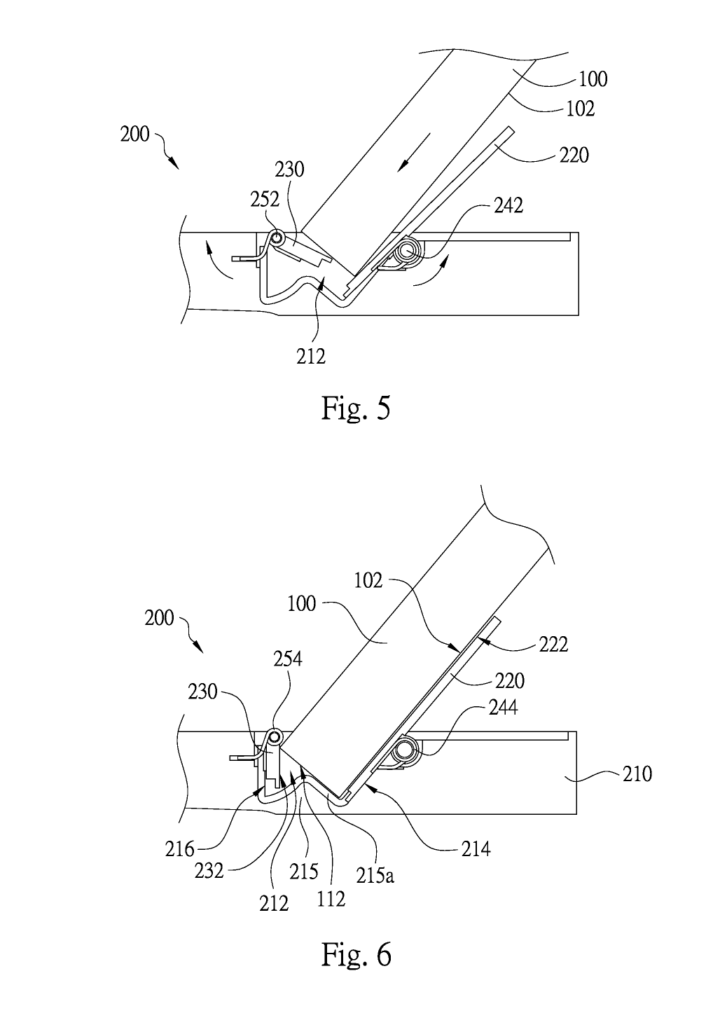

FIG. 5 and FIG. 6 are cross-sectional views of the display panel 100 and the supporting structure 200 along line A-A of FIG. 2 when the display panel 100 is inserted to the supporting structure 200. Reference is made to FIG. 5 first. The display panel 100 moves to the supporting structure 200 and touches the first plate 220 of the supporting structure 200, such that the first plate 220 rotates counterclockwise relative to the body 210 to expose the groove 212. Subsequently, the display panel 100 touches the second plate 230, such that the second plate 230 rotates clockwise relative to the body 210 while the first plate 220 still rotates counterclockwise relative to the body 210. In other words, the first plate 220 and the second plate 230 rotate around opposite directions and store bounce forces with opposite directions, respectively.

Reference is made to FIG. 6. The side 112 of the display panel 100 touches the first inclined plane 215a of the mountain-shaped structure 215 of the groove 212 when the display panel 100 is continuously moving into the supporting structure 200. The first plate 220 abuts against the first side 214 of the groove 212, the second plate 230 abuts against the second side 216 of the groove 212, and the side 102 of the display panel 100 leans on the main surface 222 of the first plate 220. It is noticed that the torque springs 244 and 254 still store bounce forces, i.e., the first plate 220 has the bounce force being able to rotate clockwise, and the second plate 230 has the bounce force being able to rotate counterclockwise, such that the display panel 100 is able to be clamped by the first plate 220 and the second plate 230, so as to be fixed between the first plate 220 and the first inclined plane 215a and in the groove 212.

Reference is made back to FIG. 3. In one or more embodiments, the main body 210 of the supporting structure 200 can include a keyboard 218, which can be electrically connected to the display panel 100 (see FIG. 2) via the groove 212 when the display panel 100 is inserted to the supporting structure 200. For example, the keyboard 218 can include a first connector extending to the first inclined plane 215a (see FIG. 4) of the groove 212, and the display panel 100 can include a second connector disposed at the side 112 of the display panel 100. The first connector of the keyboard 218 can be connected to the second connector of the display panel 100 when the display 100 is inserted to the supporting structure 200, such that the keyboard 218 and the display panel 100 are electrically connected, and a user can input signals to the display panel 100 using the keyboard 218. However, the scope of the claimed invention should not be limited in this respect.

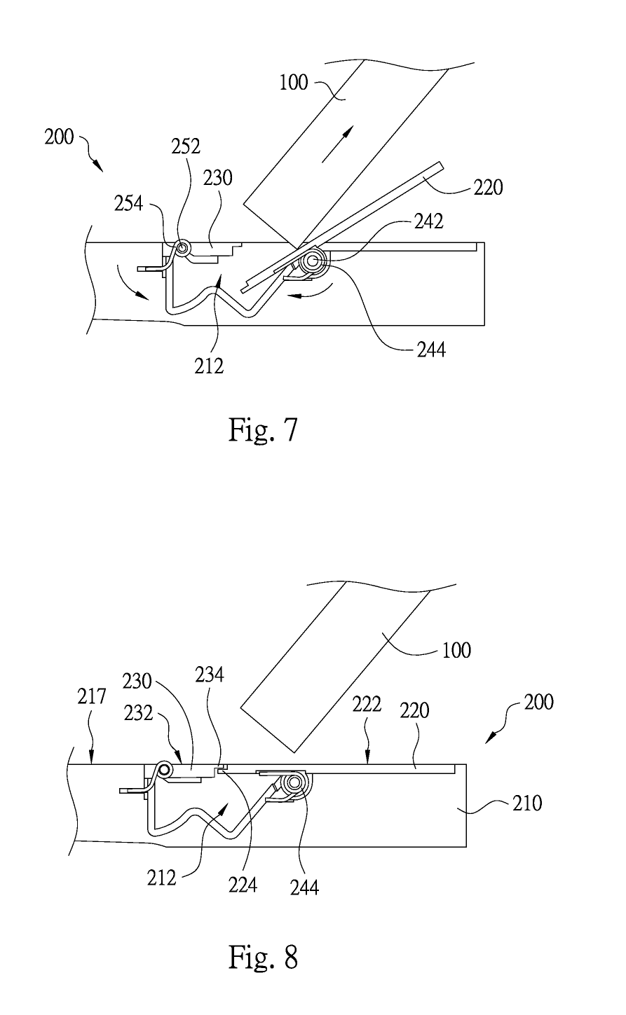

FIG. 7 and FIG. 8 are cross-sectional views of the display panel 100 and the supporting structure 200 when the display panel 100 is detached from the supporting structure 200, where the cross-sectional positions of FIG. 7 and FIG. 8 are the same as that of FIG. 6. Reference is made to FIG. 7 first. When the display panel 100 is detached from the supporting structure 200 initiated from the state of FIG. 6, i.e., when the display panel 100 moves away the supporting structure 200, the display panel 100 first moves away the second plate 230, such that the second plate 230 rotates counterclockwise relative to the main body 210 and covers a portion of the groove 212 due to the bounce force of the torque spring 254. Simultaneously, the first plate 220 rotates clockwise relative to the main body 210 and covers another portion of the groove 212 due to the bounce force of the torque spring 244. Therefore, the first plate 220 and the second plate 230 together cover the groove 212 again.

In one or more embodiments, the first main surface 222 of the first plate 220 and the second main surface 232 of the second plate 230 can be at the same surface. Moreover, the surfaces 222 and 232 and a surface 217 of the main body 210 can be at the same surface to form a flat surface, so as to beautify the appearance of the supporting structure 200.

Reference is made to FIG. 8. In one or more embodiments, the first plate 220 can include a first bump portion 224, and the second plate 230 can include a second bump portion 234. The first bump portion 224 can overlap at least a portion of the second portion 234 to prevent the dust from getting inside of the main body 210 of the supporting structure 200 through the groove 212.

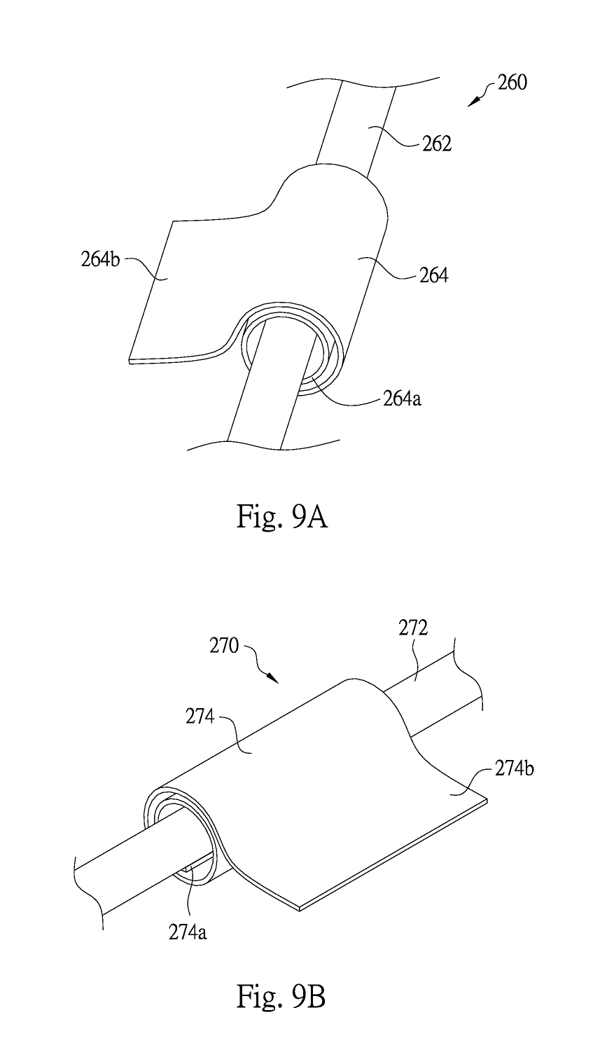

FIG. 9A is a three-dimensional view of the first elastic assembly 260 according to another embodiment of the present invention. In this embodiment, the first elastic assembly 260 can include a pivot 262 and a spring strip 264. A terminal 264a of the spring strip 264 is fixed to the pivot 262. Moreover, FIG. 9B is a three-dimensional view of the second elastic assembly 270 according to another embodiment of the present invention. The second elastic assembly 270 can include a pivot 272 and a spring strip 274. A terminal 274a of the spring strip 274 is fixed to the pivot 272.

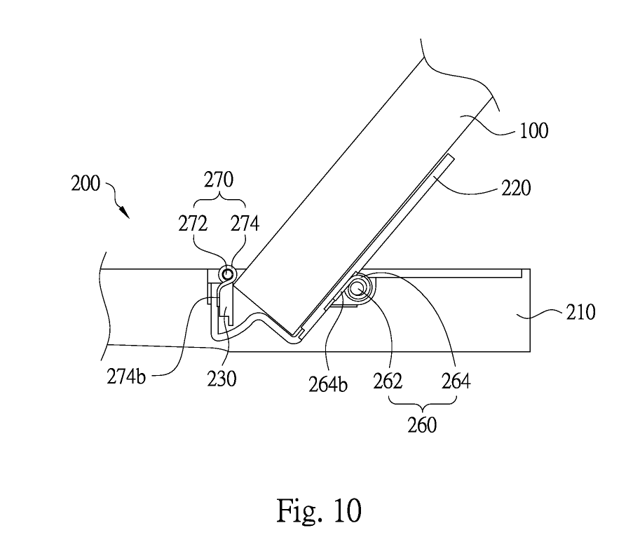

FIG. 10 is a cross-sectional view of the electronic device according to another embodiment of the present invention. The pivot 262 of the first elastic assembly 260 can rotate relative to the main body 210, and a terminal 264b of the spring strip 264 can be fixed or abutted against the surface of the first plate 220. The pivot 272 of the second elastic assembly 270 can rotate relative to the main body 210, and a terminal 274b of the spring strip 274 can be fixed or abutted against the surface of the second plate 230. Therefore, in this embodiment, the first elastic assembly 260 and the second elastic assembly 270 can together clamp the display panel 100 due to the bounce forces of the spring strips 264 and 274 when the display panel 100 is inserted to the supporting structure 200, and the spring strips 264 and 274 respectively let the first plate 220 and the second plate 230 bounce back to cover the groove 212 when the display panel 100 is detached away the supporting structure 200.

It is noticed that although the terminals 264b and 274b of the spring strips 264 and 274 are respectively disposed at the surfaces of the first plate 220 and the second plate 230 in this embodiment, the terminals 264b and 274b of the spring strips 264 and 274 can be embedded into the first plate 220 and the second plate 230 in other embodiments. An embodiment falls within the scope of the claimed invention if the terminals 264b and 274b of the spring strips 264 and 274 can be respectively fixed on the first plate 220 and second plate 230.

Moreover, although the supporting structure 200 includes the first elastic assembly 260 and the second elastic assembly 270 in this embodiment, the supporting structure 200 can include first elastic assembly 240 (see FIG. 4) and the second elastic assembly 270, or include first elastic assembly 260 and the second elastic assembly 250 (see FIG. 4) in other embodiments. Other features of the electronic device are the same as those of the electronic device shown in FIG. 4, and therefore, a description in this regard will not be provided hereinafter.

In summary, since the supporting structure 200 according to the above embodiments of the present invention is composed by simple mechanism assemblies, it has advantages such as low cost, easy operation, and good appearance aesthetic. Moreover, the simple mechanism assemblies is easier to be dissembled and assembled when repairing the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A supporting structure, comprising:
a body having a groove for accommodating a display panel;
a first plate disposed on a first side of the groove;
a second plate disposed on a second side of the groove opposite to the first side;
a first elastic assembly pivotally connecting the first plate and the body; and
a second elastic assembly pivotally connecting the second plate and the body,
wherein the first elastic assembly and the second elastic assembly clamp the display panel when the display panel is inserted to the groove of the body, and the first elastic assembly and the second elastic assembly together cover the groove when the display panel is detached from the body.

2. The supporting structure of claim 1, wherein the groove further comprises a mountain-shaped structure having a first inclined plane and a second inclined plane, the first inclined plane and the second inclined plane respectively connecting the first side and the second side,
wherein the display panel is fixed between the first inclined plane and the first plate when the display panel is inserted to the groove.

3. The supporting structure of claim 2, wherein the first elastic assembly and the second elastic assembly clamp the display panel respectively with a first elastic force and a second elastic force when the display panel is inserted to the groove of the body, wherein the direction of the first elastic force is opposite to the direction of the second elastic force.

4. The supporting structure of claim 3, wherein the first plate comprises a first bump portion, and the second plate comprises a second bump portion, the first bump portion overlaps at least a portion of the second bump portion when the first plate and the second plate together cover the groove.

5. The supporting structure of claim 1, wherein the first elastic assembly comprises a pivot and a torque spring, wherein a terminal of the torque spring is fixed on the groove, and the other terminal of the torque spring is fixed on the first plate.

6. The supporting structure of claim 1, wherein the first elastic assembly comprises a pivot and a spring strip, wherein a terminal of the spring strip is fixed on the pivot, and the other terminal of the spring strip is fixed on the first plate.

7. An electronic device, comprising:
a display panel; and
a supporting structure, comprising:
a body having a keyboard and a groove for accommodating a display panel;
a first plate disposed on a first side of the groove;
a second plate disposed on a second side of the groove opposite to the first side;
a first elastic assembly pivotally connecting the first plate and the body; and
a second elastic assembly pivotally connecting the second plate and the body,
wherein the first elastic assembly and the second elastic assembly clamp the display panel when the display panel is inserted to the groove of the body, and the first elastic assembly and the second elastic assembly together cover the groove when the display panel is detached from the body.

8. The electronic device of claim 7, wherein the groove further comprises a mountain-shaped structure having a first inclined plane and a second inclined plane, the first inclined plane and the second inclined plane respectively connecting the first side and the second side,
wherein the display panel is fixed between the first inclined plane and the first plate when the display panel is inserted to the groove.

9. The electronic device of claim 8, wherein the first elastic assembly and the second elastic assembly clamp the display panel respectively with a first elastic force and a second elastic force when the display panel is inserted to the groove of the body, wherein the direction of the first elastic force is opposite to the direction of the second elastic force.

10. The electronic device of claim 9, wherein the first plate comprises a first bump portion, and the second plate comprises a second bump portion, the first bump portion overlaps at least a portion of the second bump portion when the first plate and the second plate together cover the groove.
